(19) United States
(12) Patent Application Publication
(10) Pub. No.: US 2023/0059708 A1
(43) Pub. Date: Feb. 23, 2023

(54) Generation of Optimized Hyperparameter Values for Application to Machine Learning Tasks

(71) Applicant: Google LLC, Mountain View, CA (US)

(72) Inventors: Luke Shekerjian Metz, San Francisco, CA (US); Ruoxi Sun, Mountain View, CA (US); Christian Daniel Freeman, San Francisco, CA (US); Benjamin Michael Poole, San Francisco, CA (US); Niru Maheswaranathan, Sunnyvale, CA (US); Jascha Narain Sohl-Dickstein, San Francisco, CA (US)

(21) Appl. No.: 17/797,966

(22) PCT Filed: Feb. 8, 2021
(86) PCT No.: PCT/US2021/017053

§ 371 Date: Aug. 5, 2022

Related U.S. Application Data
(60) Provisional application No. 62/970,999, filed on Feb. 6, 2020.

(51) Int. Cl. G06N 3/08

(52) U.S. Cl. CPC G06N 3/084

(57) ABSTRACT

The present disclosure provides a computer-implemented method for determining an optimized list of sets of hyperparameter values for application to an additional machine learning task. The method includes obtaining data describing a plurality of different machine learning tasks. The method includes obtaining a plurality of candidate sets of hyperparameter values. The method includes determining an ordered list of sets of hyperparameters selected from the plurality of candidate sets of hyperparameter values, wherein the ordered list of sets of hyperparameters minimizes an aggregate loss over the plurality of different machine learning tasks. The method includes storing the ordered list of sets of hyperparameters for use in training an additional machine learning model to perform an additional machine learning task.

### RELATED APPLICATION

The present application is based on and claims benefit of U.S. Provisional Patent Application No. 62/970,999 having a filing date of Feb. 6, 2020, which is incorporated by reference herein.

### FIELD

The present disclosure relates generally to hyperparameter optimization. More particularly, the present disclosure relates to determining optimal hyperparameter values for machine learning tasks.

### BACKGROUND

Machine-learned models are constructed and trained using a variety of hyperparameters. Although traditionally these hyperparameters have been selected manually, more state of the art machine-learned models are instead constructed using learned hyperparameter values (e.g., selected by another machine-learned model). However, the selection of hyperparameters for the optimization functions used to train machine-learned models are still generally selected manually. As machine-learned models grow more complex, and necessarily include more hyperparameters, the hand-selection of hyperparameter values becomes increasingly inefficient.

Due to the significant efficiency and performance cost associated with hand-selection of optimization hyperparameters, recent efforts have focused on learned selection of hyperparameter values. Many of these efforts have attempted implementing quasi-random search algorithms over a pre-specified grid of hyperparameters. However, these attempts have generally proven to be prohibitively inefficient (e.g., consume undesirably large amounts of computing resources such as processor usage, memory usage, and/or bandwidth usage).

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for determining an optimized list of sets of hyperparameter values for application to an additional machine learning task. The computer-implemented method can include obtaining, by one or more computing devices, data describing a plurality of different machine learning tasks. The computer-implemented method can include obtaining, by the one or more computing devices, a plurality of candidate sets of hyperparameter values. The computer-implemented method can include determining, by the one or more computing devices, an ordered list of sets of hyperparameters selected from the plurality of candidate sets of hyperparameter values, wherein the ordered list of sets of hyperparameters minimizes an aggregate loss over the plurality of different machine learning tasks. The computer-implemented method can include storing, by the one or more computing devices, the ordered list of sets of hyperparameters for use in training an additional machine learning model to perform an additional machine learning task.

Another example aspect of the present disclosure is directed to a computer-implemented method for training a machine-learned model. The computer-implemented method can include obtaining, by one or more computing devices, an optimized list of sets of hyperparameters to train an additional model to perform an additional machine learning task, wherein the optimized list of sets of hyperparameters minimizes an aggregate loss over a plurality of different tasks. The computer-implemented method can include accessing, by the one or more computing devices, training data. The computer-implemented method can include training, by the one or more computing devices, the model on the training data and according to at least one set of hyperparameters from the optimized list of sets of hyperparameters.

Another example aspect of the present disclosure is directed to a computing system. The computing system can include one or more processors and one or more non-transitory computer-readable media that collectively store instructions that, when executed by the one or more processors, can cause the computing system to perform operations. The operations can include obtaining data describing a plurality of different machine learning tasks. The operations can include obtaining a plurality of candidate sets of hyperparameter values. The operations can include determining an ordered list of sets of hyperparameters selected from the plurality of candidate sets of hyperparameter values, wherein the ordered list of sets of hyperparameters minimizes an aggregate loss over the plurality of different machine learning tasks. The operations can include storing the ordered list of sets of hyperparameters for use in training an additional machine learning model to perform an additional machine learning task.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that generates an ordered list of sets of hyperparameters according to example embodiments of the present disclosure.

FIG. 1B depicts a block diagram of an example computing device that generates an ordered list of sets of hyperparameters according to example embodiments of the present disclosure.

FIG. 1C depicts a block diagram of an example computing device that generates an ordered list of sets of hyperparameters according to example embodiments of the present disclosure.

FIG. 2 depicts a depicts a flow diagram of an example method for training an additional model based on an ordered list of sets of hyperparameters according to example embodiments of the present disclosure.

FIG. 3 depicts a flow chart diagram of an example method to generate a list of optimized sets of hyperparameters according to example embodiments of the present disclosure.

Reference numerals that are repeated across plural figures are intended to identify the same features in various implementations.

### DETAILED DESCRIPTION

### Overview

Generally, the present disclosure is directed to generating an ordered list of hyperparameter values for application to an additional machine learning task. More particularly, the present disclosure is directed to generating an ordered list of sets of hyperparameters that can be utilized generally across a wide variety of machine learning tasks. By generating an ordered list of sets of hyperparameters that are found to increase performance across a variety of tasks, the inefficiency associated with hand-selection of hyperparameters can be substantially decreased. Stated differently, a list of sets of hyperparameters that have been found to perform well for many different machine learning tasks can provide an excellent starting place for the creation and training of new machine-learned models applied to new machine learning tasks, thereby enabling more efficient model creation and training and reducing the usage of computing resources such as processor, memory, and/or bandwidth usage.

More particularly, the selection of hyperparameters for the optimization functions used to train machine-learned models are still generally selected manually. As machine-learned models grow more complex, and necessarily include more hyperparameters, the hand-selection of hyperparameter values becomes increasingly inefficient. Due to the significant efficiency and performance cost associated with hand-selection of optimization hyperparameters, recent efforts have focused on learned selection of hyperparameter values. Many of these efforts have attempted implementing quasi-random search algorithms over a pre-specified grid of hyperparameters. However, these attempts have generally proven to be prohibitively inefficient.

In response to this problem, example embodiments of the present disclosure obtain data describing a plurality of different machine learning tasks (e.g., image recognition, natural language processing, etc.) and obtain a plurality of candidate sets of hyperparameter values. With the machine learning tasks and the candidate sets of hyperparameter values, an ordered list of sets of hyperparameters can be selected from the plurality of candidate sets of hyperparameter values. The ordered list of sets of hyperparameters can be selected to minimize an aggregate loss over the plurality of different machine-learning tasks (e.g., an aggregate of the respective loss of usage of the candidate sets of hyperparameter values for the different machine learning tasks, etc.).

More particularly, data describing a plurality of different machine learning tasks can be obtained. In some implementations, a task can be fined as a set of functions. For example, a task of the plurality of different machine learning tasks can include an initialization function (e.g., initializing initial parameter values, etc.), data generator (e.g., data split, train/validation/test->batch of data, etc.), forward pass (e.g., batch of data, params->loss, etc.), and compute gradients (e.g., input data, params->gradients (dloss/dparams), etc.). In some implementations, a task can have no tunable hyperparameters, and, coupled with an optimizer, can provide all necessary information to train using first order optimization.

In some implementations, the plurality of different machine learning tasks can be obtained by sampling various data source(s) (e.g., neural network architecture(s), activation function(s), dataset(s), etc.). These source(s) can be organized into similar families of tasks. As an example, a task family can be or otherwise include an mlp family that includes multi-layer perceptrons trained on image data. As another example, a task family can be or otherwise include an mlp_ae family that includes multi-layer perceptron based autoencoders trained on image data. As another example, a task family can be or otherwise include an mlp_vae family that includes multi-layer perceptron based variational autoencoder trained on image data. As another example, a task family can be or otherwise include an m_text_classification family that includes text classification tasks using recurrent neural network models. As such, it should be broadly understood that the plurality of different machine learning tasks can be any sort of machine learning task (e.g., text classification, language modeling, non volume preserving flows, image classification, quadratic operations, synthetic optimization tasks, etc.) and can be performed using any sort of model architecture (e.g., recurrent neural network(s), convolutional neural network(s), multi-layer perceptrons, autoencoder(s), variational autoencoder(s), etc.).

A plurality of candidate sets of hyperparameter values can be obtained. In some implementations, a candidate set of hyperparameter values can include an optimization algorithm and all corresponding optimizer hyperparameter(s) (e.g., learning rate, etc.).

An ordered list of sets of hyperparameters can be determined by selecting the list of sets from a plurality of candidate sets. The ordered list of sets of hyperparameters can minimize an aggregate loss over the plurality of different machine learning tasks. More particularly, in some implementations, a respective loss can be evaluated for each of the plurality of candidate sets of values for each of the different machine learning tasks over a plurality of selection iterations. After evaluating a respective loss for each of the candidate sets, a candidate set can be identified that provides, in combination with all previously selected sets of hyperparameter values, a minimum alternative loss over the plurality of different machine learning tasks.

In some implementations, the identified candidate set of hyperparameter values can be added to the ordered list of sets. Additionally, the identified candidate set can be removed from the plurality of candidate sets. In such fashion, an optimal set of hyperparameter values can be identified and selected, and also removed from the list of candidate sets to prevent additional selection of the set.

In some implementations, the diversity of the task dataset can sometimes lead to losses that span multiple orders of magnitude, making direct aggregation of performance problematic. To remedy this, the loss values can be normalized. As an example, for all tasks, the tasks can be normalized linearly between 0 and 1, where 1 is validation loss at initialization and 0 is the lowest validation loss achieved by any tested optimizer. Loss values greater than the loss at initialization can be clipped to 1.

In some implementations, to determine a scalar cost from the entire normalized training curve, the mean normalized loss can be computed over a plurality of iterations (e.g., 10,000 iterations, etc.), which in some implementations can be roughly equivalent to finding the minimum. Alternatively, in some implementations, other methods can be utilized to determine a scalar cost (e.g., performance profiles, nash averaging, etc.).

As another example, the learned search strategy can be parameterized as an ordered list of optimizers to try (e.g., a list of hyperparameter configurations, etc.). Given a fixed number of task evaluations, a goal can be to achieve the best possible performance on all tasks in the training set of tasks. As an example, for a length k list of optimizers, the loss can be defined as:

$$J ( {θ}_{1 , … , k} ) = {\sum }_{τ ∈ tasks} [ {min}_{i ∈ 1 ¨ k} f ( τ , {θ}_{i} ) ]$$

where θᵢ are the optimizer hyperparameters for element i in the list, and f is an appropriately normalized loss computed after training task τ. Accordingly, to continue the previously described example, the search for an optimal list of optimizers can be defined as:

θ*_{1, . . . ,k}=θ_{1, . . . ,k}J(θ_{1, . . . ,k})

However, searching for an optimal list of optimizers can be computationally expensive. As such, in some implementations, an approximation can be utilized. As an example, the unconstrained search for the determination of a subset of sets can be shifted from a search across an infinite number of sets to instead search over a finite number of sets to obtain the plurality of candidate sets of hyperparameter values Θ. Additionally, or alternatively, in some implementations, a heuristic can be utilized to approximate the combinatorial search over k candidate sets of hyperparameter values.

As an example, for a single trial of a candidate set of hyperparameters (e.g., k=1, etc.), the best performing candidate set on average across all training tasks can be selected. Then, additional set(s) of candidate hyperparameters can continue to be selected such that the minimum of all candidate sets per task, aggregated over all tasks, is minimized. This can shift the complexity associated with determination of the ordered list of sets from exponential to linear. As such, in some implementations, determination of the ordered list of sets of hyperparameters can be defined as:

$${θ}_{1}^{*} {=}_{θ ∈ Θ} [ {\sum }_{τ ∈ tasks} f ( τ , θ ) ]$$

$${θ}_{k}^{*} {=}_{θ ∈ Θ} [ {\sum }_{τ ∈ tasks} [ min ( b , f ( τ , θ ) ) ] ]$$

$$where b = {min}_{i ∈ 1 .. ( k - 1 )} f ( τ , {θ}_{i}^{*} ) .$$

It should be noted that, in some implementations, the first argument of the outer min, b, can be computed once per set of hyperparameters as it does not depend on θ. Finally, as the plurality of different machine learning tasks are generally stochastic, the ordered list of sets of hyperparameters can be ordered based at least in part on validation loss and/or report test loss. In some implementations, this search can necessitate an original search space with which to collect data and build the plurality of candidate sets of hyperparameter values from.

In some implementations, the loss across each task can be normalized. More particularly, as an example, to score a task, parameters of the task can be initialized and a plurality of iterations of an optimizer can be executed (e.g., 10,000 iterations, etc.). A loss can be monitored on each data split (e.g., train, validation, test, etc.) after a certain number of steps using an average over a certain number of mini-batches per evaluation (e.g., 50 mini batches per 200 steps, etc.). Additionally, the averages can be computed over select, random task parameter initializations.

In some implementations, one or more of the plurality of candidate sets of hyperparameter values can include an optimization algorithm. As an example, at least one of the plurality of candidate sets can include an NAdamW optimizer. As another example, at least one of the plurality of candidate sets can include an Adam8p optimizer. In some implementations, the one or more of the plurality of candidate sets of hyperparameter values can be or otherwise include a modified optimizer from a family of optimizers. For example, the plurality of candidate sets of hyperparameter values can include an NAdam optimizer with cosine rate decay and/or weight decay. As another example, the plurality of candidate sets of hyperparameter values can include an ADAM optimizer with additional hyperparameters for control of learning rate, learning rate decay (e.g., exponential learning rate decay, linear learning rate decay, etc.), regularization term(s), and/or any other hyperparameter(s).

As an example, at least one of the plurality of candidate sets can be selected from the NAdamW optimizer family. The candidate set of hyperparameters can include 10 hyperparameters: the base learning rate, α_{base}, first and second moment momentum, β₁, β₂, the numerical stability term, ε, l_{2WD} l₂ regularization strength, l_{2AdamW} AdamW style weight decay, and a boolean to switch between NAdam and Adam, bᵤₛₑₙₑₛₜₑᵣₒᵥ. In some implementations, the learning rate schedule can be based off of a single cycle cosine decay with a warmup, and can be controlled by 3 additional parameters: c_{warmup}, c_{constant}, and c_{minlearningratemult}. As such, the learning rate hyperparameter can be defined as:

$$u = {c}_{w a r m u p} T > t ,$$

$${α}_{decay \& constant} = ( {α}_{b a s e} - {c}_{min learning grate mult} ) ( 0.5 cos ( t π / ( T - {c}_{c o n s t a n t} ) ) + 0.5 ) + {c}_{min learning grate mult}$$

$${α}_{w a r m u p} = \frac{t}{( T {c}_{w a r mup} )}$$

$$α = ( 1 - u ) {α}_{decay \& constant} + u {α}_{w a r m}$$

In some implementations, the additional machine learning task can be a different type of task than the types of tasks in the plurality of different machine learning tasks. More particularly, the ordered list of sets selected for the distribution of tasks (e.g., the plurality of different machine learning tasks, etc.) can also be generalized and be utilized for tasks that are of a different type than the plurality of different machine learning tasks. As an example, the plurality of different tasks can include a plurality of various image-based tasks (e.g., image recognition, object recognition, image reconstruction, image generation, image encryption, etc.). The ordered list of sets of hyperparameters can then be utilized for task(s) outside the task distribution (e.g., tasks for analysis of data, etc.). In such fashion, the ordered list of sets of hyperparameters can serve as a generalized list of sets that can facilitate out of distribution transfer learning.

The systems and methods of the present disclosure can provide a number of technical effects and benefits. As an example technical effect and benefit, by generating an ordered list of generalized hyperparameter sets, new machine-learned model optimizations can iterate through the list of hyperparameter sets to find an efficient optimization solution instead of hand-selecting hyperparameter values. In such fashion, the significant amount of inefficiency and cost associated with hand-selection of hyperparameter values can be drastically reduced.

As another technical effect and benefit, the generation of an ordered list of generalized hyperparameter sets can, for some machine-learned model implementations, obviate the need to perform pseudo-random search operations to select hyperparameters. This, in turn, can significantly reduce the amount of energy, memory, and computational power required to select hyperparameters using pseudo-random search algorithms.

Aspects of the present disclosure can optionally be implemented in and/or provided by a cloud-based machine learning as a service platform. For example, the platform can store and use the ordered list of sets of hyperparameters to train models for clients of the platform. As another example, communication between the service platform, clients, and various other computing devices and/or systems can occur via one or more application programming interfaces. Similarly, learning can be done in a distributed fashion between the service platform and any other associated computing systems and/or devices (e.g., distributed learning of a plurality of models using various hyperparameters to parallelize the testing of sets of hyperparameters).

With reference now to the Figures, example embodiments of the present disclosure will be discussed in further detail.

### Example Devices and Systems

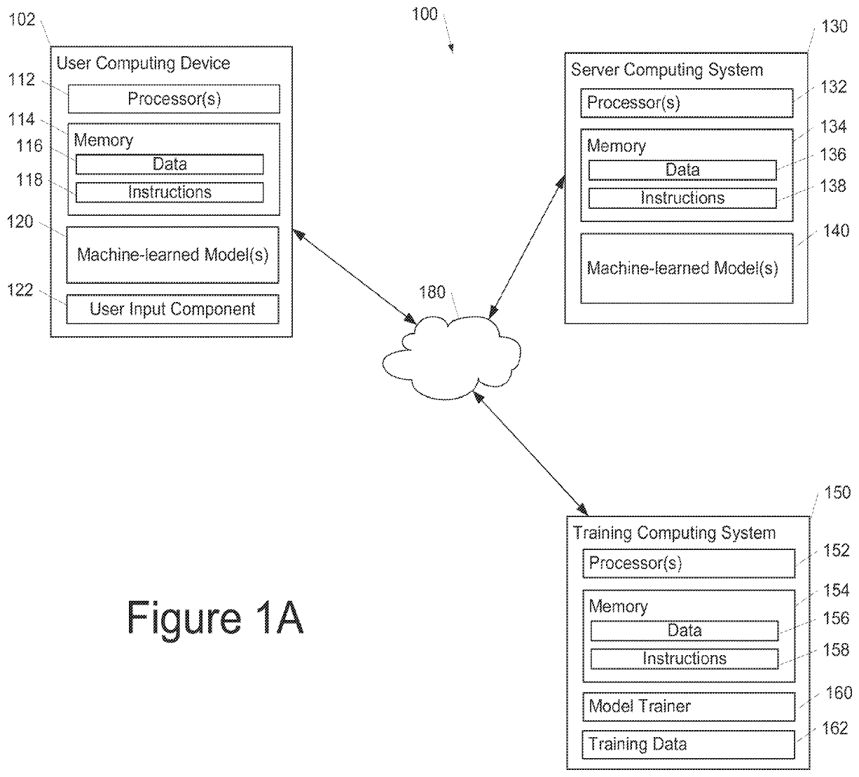

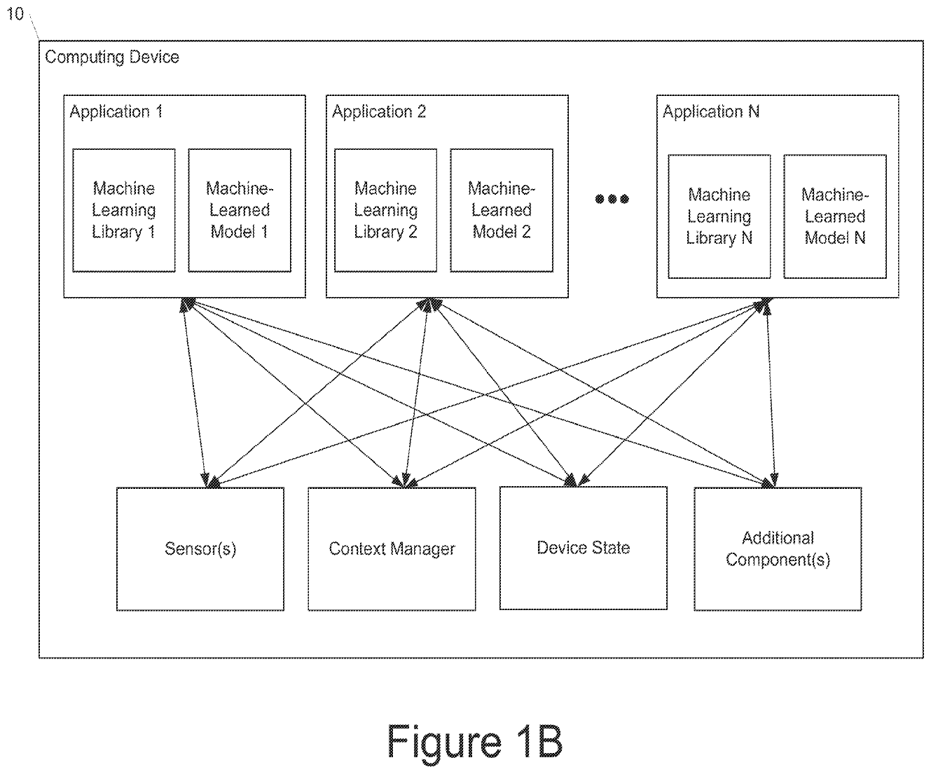

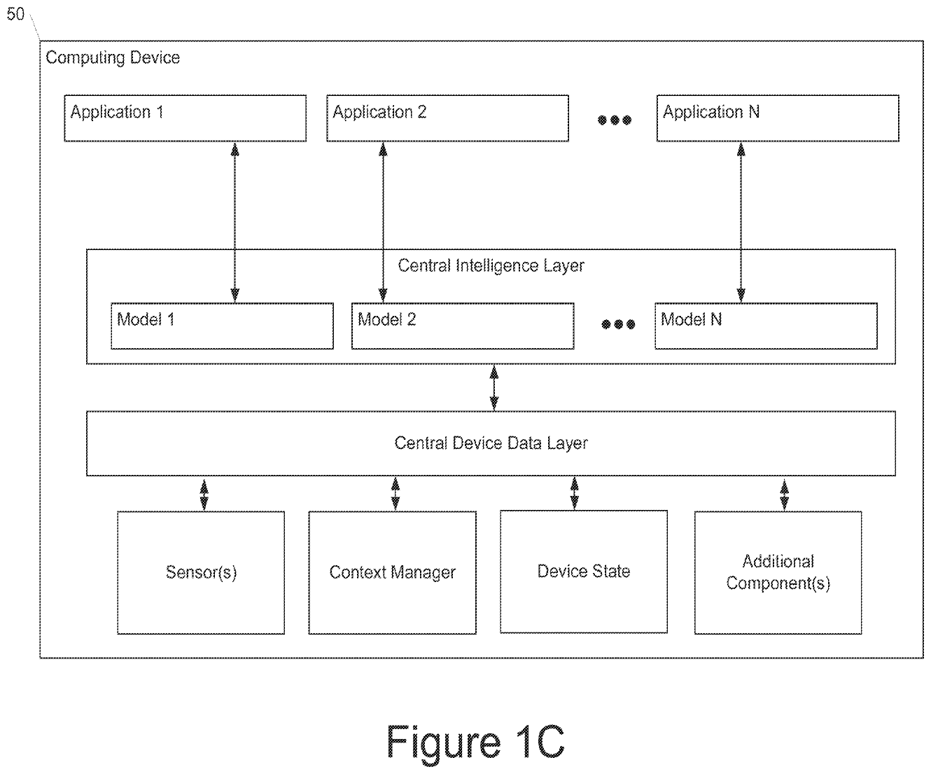

FIG. 1A depicts a block diagram of an example computing system 100 that generates an ordered list of sets of hyperparameters according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120 (e.g., to perform parallel training operations across multiple instances of the model).

Additionally or alternatively, one or more models 140 can be included in or otherwise stored and implemented by the server computing system 130 that communicates with the user computing device 102 according to a client-server relationship. For example, the models 140 can be implemented by the server computing system 140 as a portion of a web service (e.g., a hyperparameter optimization service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162. More particularly, the model trainer 160 can perform the parameter search techniques described herein by training machine-learned model(s) (e.g., machine-learned model(s) 120, machine-learned model(s) 140, etc.) and evaluating their performance.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

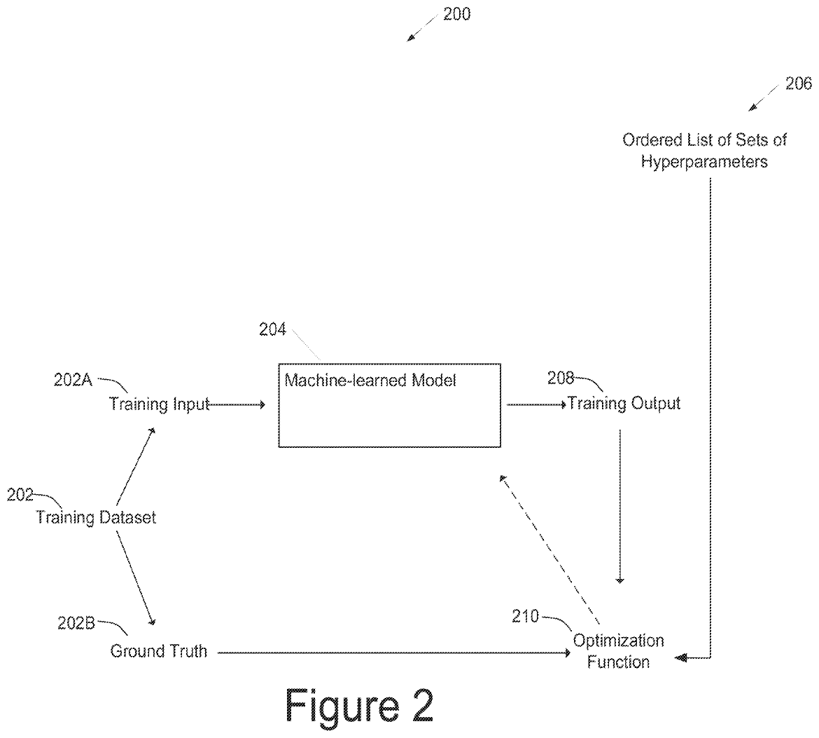

FIG. 2 depicts a depicts a flow diagram of an example method 200 for training an additional machine-learned model 204 based on an ordered list of sets of hyperparameters 206 according to example embodiments of the present disclosure. More particularly, a training dataset 202 can include sets of training inputs 202A (e.g., training images, training text, etc.) that has an associated ground truth 202B. Therefore, the training output 208 provided by the machine-learned model 204 for each training input 202A can be compared to the associated ground truth 202B using an optimization function 308.

The optimization function 308 can be, or otherwise include, one or more optimization algorithms and/or corresponding lists of sets of hyperparameters from the ordered list of sets of hyperparameters 206. As an example, the optimization function 210 can be the set of hyperparameters ordered first in the ordered list of sets of hyperparameters 206 (e.g., an optimization algorithm and associated hyperparameter values). For example, the optimization function (e.g., taken or otherwise including elements from the ordered list of sets of hyperparameters 206) can be an ADAM optimization algorithm with associated hyperparameter values. The optimization function 210 can be used to train the machine-learned model 204. For example, the values of the parameters of the machine-learned model 204 can be updated in accordance with the optimization function 210 and associated hyperparameters as the optimization function 210 is backpropagated through the machine-learned model 204.

### Example Methods

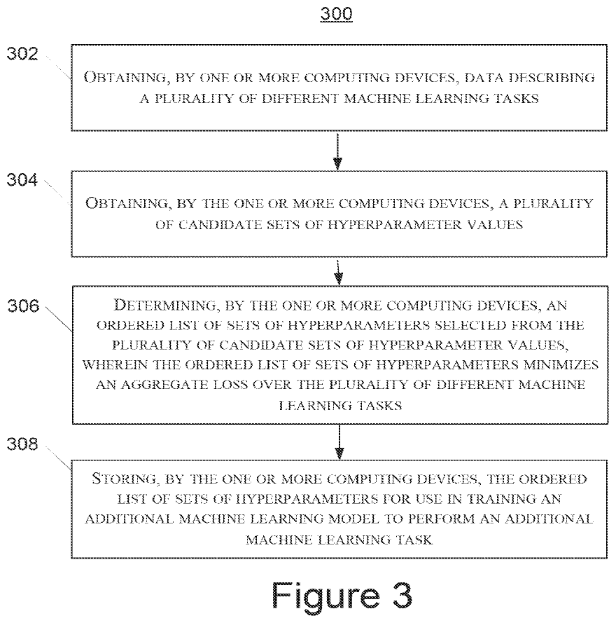

FIG. 3 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain data describing a plurality of different machine learning tasks. In some implementations, each machine learning task of the plurality of different machine learning tasks can include a plurality of machine learning operations. The machine learning operations can include, for example, initializing one or more parameter values of a machine-learned model. As another example, the machine learning operations can include generating one or more batches of data (e.g., training data, validation data, test data, etc.). As another example, the machine learning operations can include inputting one or more batches of data to the machine-learned model to receive an output. As another example, the machine learning operations can include determining one or more parameter updates for the machine-learned model based at least in part on the output.

In some implementations, the plurality of different machine learning tasks can be and/or include previous jobs performed by a learning system. As an example, the different machine learning tasks can include one or more image recognition tasks that were previously performed by the learning system. In some implementations, the plurality of different machine learning tasks can be and/or include user-defined and/or user-specified tasks. As an example, a user can manually define the operations (e.g., the initialized parameters, data generation, outputs, etc.) of the machine-learned task.

In some implementations, obtaining data describing a plurality of different machine learning tasks can include generating one or more machine learning tasks of the plurality of different machine learning tasks based on a random sampling of a one or more neural network properties. As an example, neural network properties can include neural network architectures, activation functions, model datasets, and other such neural network features.

At 304, the computing system can obtain a plurality of candidate sets of hyperparameter values. Hyperparameters can include, but are not limited to, a number of layers in a model, a type of layers, a configuration of layers, a learning rate, a number of clusters in a K-means tree, a number of training epochs, momentum, a regularization constant, etc. In some implementations, each of the plurality of candidate sets of hyperparameter values can include an identification of one of a number of potential optimization algorithms. As an example, a candidate set of hyperparameter values may include an identification of an ADAM gradient optimization algorithm. In some implementations, each of the plurality of candidate sets of hyperparameter values can include hyperparameter values for the one of the number of potential optimization algorithms (e.g., a learning rate associated with an ADAM gradient optimization algorithm, etc.).

At 306, the computing system can determine an ordered list of sets of hyperparameters selected from the plurality of candidate sets of hyperparameter values. The ordered list of sets of hyperparameters can minimize an aggregate loss over the plurality of different machine learning tasks.

In some implementations, to determine the ordered list of sets of hyperparameters, the computing system can, for a plurality of selection iterations, evaluate a respective loss for each of the plurality of candidate sets of hyperparameter values for each of the plurality of different machine learning tasks. In some implementations, the computing system can further, for a plurality of selection iterations, identify a candidate set of hyperparameter values that provides, in combination with all previously selected sets of hyperparameter values, a minimum alternative loss over the plurality of different machine learning tasks. In some implementations, the respective loss can be normalized to include and/or otherwise be a binary value.

In some implementations, identifying a candidate set of hyperparameter values can include, for a first selection iteration of a plurality of selection iterations, adding a best candidate set of hyperparameter values to the ordered list of sets of hyperparameters. The best candidate set of hyperparameters can include and/or otherwise be the lowest overall respective loss for each of the plurality of different machine learning tasks among the plurality of candidate sets of hyperparameter values. In some implementations, identifying a candidate set of hyperparameter values can include, for a first selection iteration of a plurality of selection iterations, removing the best candidate set of hyperparameter values from the plurality of candidate sets of hyperparameter values.

In some implementations, identifying a candidate set of hyperparameter values can include, for a remaining plurality of selection iterations, identifying a candidate set of hyperparameter values of the plurality of candidate sets of hyperparameter values that produces the minimum alternative loss. The minimum alternative loss can, in some implementations, include a performance difference in which the candidate set of hyperparameter values produces a lower respective loss for one or more of the plurality of machine learning tasks than a current lowest respective loss produced by one or more sets of hyperparameters of the ordered list of sets of hyperparameters for the one or more of the plurality of machine learning tasks.

In some implementations, identifying a candidate set of hyperparameter values can include, for a remaining plurality of selection iterations, adding the candidate set of hyperparameter values to the ordered list and removing the candidate set of hyperparameter values from the plurality of candidate sets of hyperparameter values.

In some implementations, the computing system can further, for a plurality of selection iterations, add the identified candidate set of hyperparameter values to the ordered list of sets of hyperparameters. In some implementations, the computing system can further, for a plurality of selection iterations remove the identified candidate set of hyperparameter values from the plurality of candidate sets of hyperparameter values.

In some implementations, determining an ordered list of sets of hyperparameters selected from the plurality of candidate sets of hyperparameter values can further include ordering the ordered list of sets of hyperparameter values based at least in part on a validation loss for each of the ordered list of sets of hyperparameters over the plurality of different machine learning tasks.

At 308, the computing system can store the ordered list of sets of hyperparameters for use in training an additional machine-learned model to perform an additional machine learning task. In some implementations, training an additional machine-learned model can include obtaining an optimized list of sets of hyperparameters to train an additional model to perform an additional machine learning task. The optimized list of sets of hyperparameters can minimize an aggregate loss over a plurality of different tasks. In some implementations, the additional machine-learned model can be different than the tasks of the plurality of different machine learning tasks or, in some implementations, can be at least one of the tasks of the plurality of different machine learning tasks.

In some implementations, training an additional machine-learned model can include accessing training data and training the model on the training data and according to at least one set of hyperparameters from the optimized list of sets of hyperparameters.

In some implementations, training can include training a plurality of variants of the model separately according to a plurality of sets of hyperparameters from the optimized list of sets of hyperparameters. In some implementations, training can include evaluating a respective performance of each variant of the model. In some implementations, training can include selecting a first variant of the model based on the respective performances of the variants of the model.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for determining an optimized list of sets of hyperparameter values for application to an additional machine learning task, the method comprising:
obtaining, by one or more computing devices, data describing a plurality of different machine learning tasks;
obtaining, by the one or more computing devices, a plurality of candidate sets of hyperparameter values;
determining, by the one or more computing devices, an ordered list of sets of hyperparameters selected from the plurality of candidate sets of hyperparameter values, wherein the ordered list of sets of hyperparameters minimizes an aggregate loss over the plurality of different machine learning tasks; and
storing, by the one or more computing devices, the ordered list of sets of hyperparameters for use in training an additional machine learning model to perform an additional machine learning task.

2. The computer-implemented method of claim 1, wherein determining the ordered list of sets of hyperparameters comprises:
for a plurality of selection iterations:
evaluating, by the one or more computing devices, a respective loss for each of the plurality of candidate sets of hyperparameter values for each of the plurality of different machine learning tasks;
identifying, by the one or more computing devices, a candidate set of hyperparameter values that provides, in combination with all previously selected sets of hyperparameter values, a minimum alternative loss over the plurality of different machine learning tasks;
adding, by the one or more computing devices, the identified candidate set of hyperparameter values to the ordered list of sets of hyperparameters; and
removing, by the one or more computing devices, the identified candidate set of hyperparameter values from the plurality of candidate sets of hyperparameter values.

3. The computer-implemented method of claim 1, wherein identifying, by the one or more computing devices, the candidate set of hyperparameter values that provides, in combination with all previously selected sets of hyperparameter values, a minimum alternative loss over the plurality of different machine learning tasks comprises:
for a first selection iteration of the plurality of selection iterations:
adding, by the one or more computing devices, a best candidate set of hyperparameter values to the ordered list of sets of hyperparameters, wherein the best candidate set of hyperparameters comprises the lowest overall respective loss for each of the plurality of different machine learning tasks among the plurality of candidate sets of hyperparameter values; and
for the remaining plurality of selection iterations:
identifying, by the one or more computing devices, a candidate set of hyperparameter values of the plurality of candidate sets of hyperparameter values that produces the minimum alternative loss, the minimum alternative loss comprising a performance difference for tasks for which the candidate set of hyperparameter values produces a lower respective loss than a current lowest respective loss produced for the task by one or more sets of hyperparameters of the ordered list of sets of hyperparameters.

4. The computer-implemented method of claim 1, wherein determining, by the one or more computing devices, an ordered list of sets of hyperparameters selected from the plurality of candidate sets of hyperparameter values further comprises ordering the ordered list of sets of hyperparameter values based at least in part on a validation loss for each of the ordered list of sets of hyperparameters over the plurality of different machine learning tasks.

5. The computer-implemented method of claim 1, wherein each machine learning task of the plurality of different machine learning tasks comprises a plurality of machine learning operations, the machine learning operations comprising:
initializing one or more parameter values of a machine-learned model;
generating one or more batches of data, the one or more batches of data comprising at least one of training data, validation data, and test data;
inputting one or more batches of data to the machine-learned model to receive an output; and
determining one or more parameter updates for the machine-learned model based at least in part on the output.

6. The computer-implemented method of claim 1, wherein obtaining, by one or more computing devices, data describing a plurality of different machine learning tasks comprises:
generating, by the one or more computing devices, one or more machine learning tasks of the plurality of different machine learning tasks based on a random sampling of one or more neural network properties.

7. The computer-implemented method of claim 1, wherein the one or more neural network properties comprise at least one of:
neural network architectures;
activation functions; or
model datasets.

8. The computer-implemented method of claim 1, wherein each of the plurality of candidate sets of hyperparameter values comprises an identification of one of a number of potential optimization algorithms.

9. The computer-implemented method of claim 1, wherein each of the plurality of candidate sets of hyperparameter values comprise hyperparameter values for the one of the number of potential optimization algorithms.

10. The computer-implemented method of claim 1, wherein the respective loss for each of the plurality of candidate sets of hyperparameter values for each of the plurality of different machine learning tasks is normalized to comprise a binary value.

11. A computer-implemented method for training a machine-learned model, the method comprising:
obtaining, by one or more computing devices, an optimized list of sets of hyperparameters to train an additional model to perform an additional machine learning task, wherein the optimized list of sets of hyperparameters minimizes an aggregate loss over a plurality of different tasks;
accessing, by the one or more computing devices, training data; and
training, by the one or more computing devices, the model on the training data and according to at least one set of hyperparameters from the optimized list of sets of hyperparameters.

12. The computer-implemented method of claim 11, wherein training comprises:
training, by the one or more computing devices, a plurality of variants of the model separately according to a plurality of sets of hyperparameters from the optimized list of sets of hyperparameters;
evaluating, by the one or more computing devices, a respective performance of each variant of the model; and
selecting, by the one or more computing devices, a first variant of the model based on the respective performances of the variants of the model.

14. The computer-implemented method of claim 12 or 13, wherein the task performed by the additional machine-learned model is different than the tasks of the plurality of different machine learning tasks.

15. The computer-implemented method of claim 12 or 13, wherein the task performed by the additional machine-learned model is at least one of the tasks of the plurality of different machine learning tasks.

16. A computing system, comprising:
one or more processors; and
one or more non-transitory computer-readable media that collectively store instructions that, when executed by the one or more processors, cause the computing system to perform operations, the operations including:
obtaining data describing a plurality of different machine learning tasks;
obtaining a plurality of candidate sets of hyperparameter values;
determining an ordered list of sets of hyperparameters selected from the plurality of candidate sets of hyperparameter values, wherein the ordered list of sets of hyperparameters minimizes an aggregate loss over the plurality of different machine learning tasks; and
storing the ordered list of sets of hyperparameters for use in training an additional machine learning model to perform an additional machine learning task.

17. The computing system of claim 16, wherein determining the ordered list of sets of hyperparameters comprises:
for a plurality of selection iterations:
evaluating a respective loss for each of the plurality of candidate sets of hyperparameter values for each of the plurality of different machine learning tasks;
identifying a candidate set of hyperparameter values that provides, in combination with all previously selected sets of hyperparameter values, a minimum alternative loss over the plurality of different machine learning tasks;
adding the identified candidate set of hyperparameter values to the ordered list of sets of hyperparameters; and
removing the identified candidate set of hyperparameter values from the plurality of candidate sets of hyperparameter values.

18. The computing system of claim 16, wherein identifying the candidate set of hyperparameter values that provides, in combination with all previously selected sets of hyperparameter values, a minimum alternative loss over the plurality of different machine learning tasks comprises:
for a first selection iteration of the plurality of selection iterations:
adding a best candidate set of hyperparameter values to the ordered list of sets of hyperparameters, wherein the best candidate set of hyperparameters comprises the lowest overall respective loss for each of the plurality of different machine learning tasks among the plurality of candidate sets of hyperparameter values; and
removing the best candidate set of hyperparameter values from the plurality of candidate sets of hyperparameter values;
for the remaining plurality of selection iterations:
identifying a candidate set of hyperparameter values of the plurality of candidate sets of hyperparameter values that produces the minimum alternative loss, the minimum alternative loss comprising a performance difference in which the candidate set of hyperparameter values produces a lower respective loss for one or more of the plurality of machine learning tasks than a current lowest respective loss produced by one or more sets of hyperparameters of the ordered list of sets of hyperparameters for the one or more of the plurality of machine learning tasks;
adding the candidate set of hyperparameter values to the ordered list; and
removing the candidate set of hyperparameter values from the plurality of candidate sets of hyperparameter values.

19. The computing system of claim 16, wherein determining an ordered list of sets of hyperparameters selected from the plurality of candidate sets of hyperparameter further comprises ordering the ordered list of sets of hyperparameter values based at least in part on a validation loss for each of the ordered list of sets of hyperparameters over the plurality of different machine learning tasks.

20. The computing system of claim 16, wherein each machine learning task of the plurality of different machine learning tasks comprises a plurality of machine learning operations, the machine learning operations comprising:
initializing one or more parameter values of a machine-learned model;
generating one or more batches of data, the one or more batches of data comprising at least one of test data, validation data, and test data;
inputting one or more batches of data to the machine-learned model to receive an output; and
determining one or more parameter updates for the machine-learned model based at least in part on the output.
